(19) United States
(12) Patent Application Publication
(10) Pub. No.: US 2017/0111744 A1
(43) Pub. Date: Apr. 20, 2017

(54) APPROACHING VEHICLE WARNING SPEAKER DEVICE

(71) Applicants: PIONEER CORPORATION, Tokyo (JP); Tohoku Pioneer Corporation, Yamagata (JP); ANDEN CO., LTD., Aichi (JP)

(72) Inventors: Kazuaki WATANABE, Yamagata (JP); Junichi SATO, Yamagata (JP); Susumu MIYATA, Aichi (JP); Makoto TSURUTA, Aichi (JP)

(21) Appl. No.: 15/129,198

(22) PCT Filed: Mar. 28, 2014
(86) PCT No.: PCT/JP2014/059364

§ 371 Date: Sep. 26, 2016

(51) Int. Cl. H04R 7/02; B60Q 5/00; H04R 1/02

(52) U.S. Cl. CPC H04R 7/02; H04R 1/026; B60Q 5/008; H04R 2400/11; H04R 2499/13; H04R 2307/204; H04R 2307/025; B60Y 2200/92

(57) ABSTRACT

An approaching vehicle warning speaker device includes a diaphragm that generates sound, an edge section joined to an outer edge of the diaphragm, and a frame supporting an outer periphery of the edge section. The diaphragm is made of a film containing polyimide. The edge section includes a base member made of fiber and rubber-containing waterproof layers provided on both sides of the base member.

### TECHNICAL FIELD

The present invention relates to an approaching vehicle warning speaker device.

### BACKGROUND ART

Pedestrians, such as a walking person, may not notice an approaching hybrid vehicle or an electric vehicle, which moves very quietly. Various types of approaching vehicle warning speaker devices are proposed to be mounted on a vehicle, such as a hybrid vehicle, to generate a warning sound to notice pedestrians of an approaching vehicle such as a hybrid vehicle. Manufacturers independently determine specifications of such approaching vehicle warning speaker devices. So that, approaching vehicle warning speaker devices are not designed based on unified standards specifying, for example, thermal resistance or environmental resistance.

The trend in recent years has shown that the method of mounting the approaching vehicle warning speaker device and the specification of the approaching vehicle warning speaker device are to be legislated. Furthermore, the approaching vehicle warning speaker device, which is mounted near an engine or a motor in a hybrid vehicle or the like, is required to have environmental resistance, such as the reproduced sound pressure, thermal resistance, moisture resistance, and water resistance for each frequency band.

One of objects of the present invention is to raise the high reproduced sound pressure and to improve thermal resistance and water resistance.

### SUMMARY OF INVENTION

### Solution to Problem

An approaching vehicle warning speaker device according to the present invention includes a diaphragm that generates sound, an edge section joined to the outer edge of the diaphragm, and a frame supporting the outer periphery of the edge section. The diaphragm is made of a film containing polyimide. The edge section includes a base member made of fiber and rubber-containing waterproof layers provided on both sides of the base member.

### BRIEF DESCRIPTION OF DRAWINGS

FIG. 1 is a perspective view illustrating an approaching vehicle warning speaker device according to a first embodiment of the present invention with a portion cut out to show a cross section; and

FIG. 2 is a perspective view illustrating the approaching vehicle warning speaker device shown in FIG. 1 viewed from the opposite side.

### DESCRIPTION OF EMBODIMENTS

An approaching vehicle warning speaker device according to one embodiment of the present invention will be described. The approaching vehicle warning speaker device according to one embodiment of the present invention includes a diaphragm that generates sound, an edge section joined to the outer edge of the diaphragm, and a frame supporting the outer periphery of the edge section. The diaphragm is made of a film containing polyimide. The edge section includes a base member made of fiber and rubber-containing waterproof layers provided on both sides of the base member.

Configured in such a manner, the provided approaching vehicle warning speaker device offers excellent thermal resistance and water resistance.

The diaphragm may have a thickness of 50 μm to 175 μm. The diaphragm may include a portion having a thickness of 125 μm.

The diaphragm having such a thickness has a required strength and provides a high reproduced sound pressure.

The base member is preferably made of a material containing cotton. The base member made of such a material allows waterproof layers to be arranged on both sides of the base member without compromising flexibility required of the edge section and thus can provide an approaching vehicle warning speaker device with excellent water resistance.

The waterproof layers provided on both sides of the base member may each include a plurality of layers. Such a configuration further improves warterproofness of the edge section.

### EMBODIMENTS

### First Embodiment

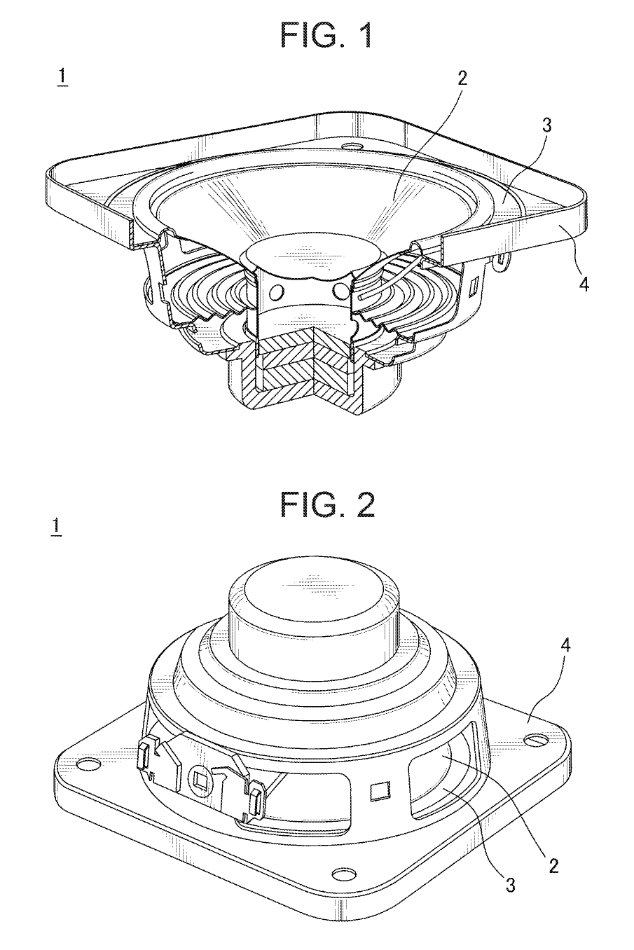

A first embodiment of an approaching vehicle warning speaker device according to the present invention will now be described with reference to FIGS. 1 and 2. An approaching vehicle warning speaker device 1 according to the embodiment is used, for example, as an approaching vehicle warning speaker device mounted on a hybrid vehicle. FIG. 1 is a perspective view illustrating the approaching vehicle warning speaker device 1 with a portion cut out to show a cross section. FIG. 2 is a perspective view illustrating the approaching vehicle warning speaker device 1 in FIG. 1 viewed from the side opposite the sound-emission side. The approaching vehicle warning speaker device 1 according to the first embodiment is not always mounted on a hybrid vehicle but may also be mounted on an electric vehicle or the like.

The approaching vehicle warning speaker device 1 includes a diaphragm 2 that generates sound, an edge section 3 joined to the outer edge of the diaphragm 2, and a frame 4 supporting the outer periphery of the edge section 3. The diaphragm 2 is made of a film containing polyimide. The edge section 3 includes a base member made of fiber and rubber-containing waterproof layers provided on both sides of the base member. The diaphragm 2 is joined to a voice coil bobbin (not shown) directly or via another member.

Such a diaphragm 2 offers improved thermal resistance and water resistance. With the edge section 3 provided as described above, thermal resistance and water resistance can be improved without compromising flexibility.

A rubber used for the edge section 3 of the embodiment includes, for example, styrene-butadiene rubber, nitryl rubber, composites of styrene-butadiene rubber and nitryl rubber, silicone rubber, and acrylic rubber.

The diaphragm 2 includes a portion having a thickness of 125 μm. The diaphragm 2 having such a thickness has a required strength and provides a high reproduced sound pressure.

The entire portion of the diaphragm 2 needs not have a thickness of 125 μm. For example, the diaphragm 2 maybe formed by pressing, for example, a polyimide film having a thickness of 125 μm. The diaphragm 2 formed in such a manner includes a portion thinner than 125 μm and a portion having a thickness of 125 μ. The thickness of the diaphragm 2 is not limited to 125 μm but may be 50 μm to 175 μm. The diaphragm 2 made of a polyimide film thinner than 50 μm may deform or break when subjected to vibration for a long time. Deformation and breakage are likely to occur near a portion joined to the voice coil, which is subjected to a large force. The diaphragm 2 made of a polyimide film having a thickness of 50 μm or larger offers excellent environmental resistance. The diaphragm 2 made of a polyimide film thicker than 175 μm will have a higher strength but cannot provide a desired reproduced sound pressure because of its larger mass.

A standard polyimide film having a thickness of 50 μm, 75 μm, 100 μm, 125 μm, or 175 μm can be used for the diaphragm 2 according to the first embodiment.

The base member of the edge section 3 is made of fiber. The edge section 3 thus offers improved thermal resistance without compromising flexibility. The fiber composing the base member is cotton, for example. Cotton shows good adhesion to the rubber-containing waterproof layers provided on both sides of the base member, enhancing waterproofness of the edge. Aramid fiber is also used as the fiber composing the base member. Use of aramid fiber enhances strength of the base member, providing an edge offering excellent environmental resistance.

The waterproof layers provided on both sides of the base member of the edge section 3 each includes a plurality of layers. This further improves waterproofness of the edge section 3.

The best mode, such as a configuration and a method, to carryout the present invention is not limited to those described above. Although description and illustration on the present invention are presented mainly for a particular embodiment, various modifications regarding the shape, material, the number of parts, and other structural details can be made for the embodiment by those skilled in the art without departing from the technical idea and the scope of the present invention.

Definitive descriptions used to describe shapes and materials are given by way of illustration to promote understanding of the present invention, not byway of limiting the scope of the present invention. Therefore, a component referred to as a name not including the above definitive description or a portion thereof falls within the scope of the present invention.

### REFERENCE SIGNS LIST

1 approaching vehicle warning speaker device

2 diaphragm

3 edge section

4 frame

1. An approaching vehicle warning speaker device comprising:
a diaphragm for generating sound;
an edge section joined to an outer edge of the diaphragm; and
a frame supporting an outer periphery of the edge section,
wherein the diaphragm is made of a film containing polyimide, and
the edge section consists of a base member made of fiber and rubber-containing waterproof layers provided on both sides of the base member.

2. The approaching vehicle warning speaker device according to claim 1, wherein the diaphragm has a thickness of 50 μm to 175 μm.

3. The approaching vehicle warning speaker device according to claim 2, wherein the diaphragm includes a portion having a thickness of 125 μm.

4. The approaching vehicle warning speaker device according to claim 1, wherein the base member is made of material containing cotton.

5. The approaching vehicle warning speaker device according to claim 4, wherein the waterproof layer provided on both sides of the base member each has a plurality of layers.
